(19) United States
(12) Patent Application Publication
(10) Pub. No.: US 2011/0318468 A1
(43) Pub. Date: Dec. 29, 2011

(54) FRUCTOSE-BASED ANTI-DIABETIC ALCOHOLIC BEVERAGE AND METHOD OF MAKING SAME

(76) Inventors: Aleksandre Kakhaberi, Atlanta, GA (US); Nodar Chigogidze, Tbilisi (GE)

(21) Appl. No.: 12/825,768

(22) Filed: Jun. 29, 2010

(51) Int. Cl. C12G 3/08; C12H 1/00; C12G 3/06

(52) U.S. Cl. 426/592; 426/429

(57) ABSTRACT

An alcoholic beverages made from topinambour bulbs that does not contain sugar syrups, glucose or vinegar acids. The topinambour bulb-based beverages utilize a specific acid-hydrolysis utilizing multiple organic acids which results in an extract that contains fructose polysaccharide components that are beneficial for diabetes prevention. For taste and for diabetes-preventing purposes, natural multi-atomic (3, 5 and 6 atoms) alcohols are also utilized. Natural colorings are optionally added to provide a desirable appearance to the beverage.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to alcoholic beverages and methods of making same, and more specifically to fructose-free alcoholic beverage made from topinambour bulbs for use particularly by diabetics.

2. Description of Related Art

There has been a tendency lately throughout the world of increased type I and II diabetic patients, to the extent that diabetes affects about 40% of the world's adult population. Diabetics are deprived of enjoying certain foods and drinks because of high sugar content therein. For this reason, world scientists are working hard to not only supply diabetic patients with versatile medications, but also provide prevention through inventing new food products and drinks for diabetics and their descendants' risk groups.

Therefore, it is readily apparent that there is a need for an alcoholic beverage that can be consumed by diabetics, wherein the alcohol beverage does not adversely impact their diabetes, and wherein the alcoholic beverage in fact improves their diabetes.

### BRIEF SUMMARY OF THE INVENTION

Briefly described, in a preferred embodiment, the present invention overcomes the above-mentioned disadvantages and meets the recognized need for such a composition by providing alcoholic beverages made from topinambour bulbs, wherein the beverages do not contain sugar syrups, glucose or vinegar acids that are utilized in other alcoholic beverages for softening and acquiring better taste. Instead, topinambour bulb-based beverages utilize a specific acid hydrolysis which results in an extract that contains fructose polysaccharide components, namely, low molecular weight compounds for taste and high molecular weight compounds for diabetes prevention purposes. The hydrolysis itself utilizes multiple organic acids. For taste and for diabetes-preventing purposes, natural multi-atomic (3, 5 and 6 atoms) alcohols are also utilized. Natural colorings are also envisioned to provide a desirable appearance to the end product.

The aromatic qualities of topinambour bulb-based alcoholic beverages are provided by utilizing herb ether oils which further have qualities that provide the ability to lower blood sugars and serve as anti-diabetic components. The presence of natural antioxidants and large amounts of free radical fighting hydroxyl groups further provide topinambour bulb-based alcohols with a radiological protective composition for those working in conditions of high radiological toxic locations.

In an alternate embodiment, thickening components are utilized to provide a more viscous beverage, particularly vodkas.

According to its major aspects and broadly stated, the present invention in its preferred form is an anti-diabetic alcoholic beverage comprising hydrolyzed topinambour extract obtained in the presence of 3.8 g/liter citric acid at a citric acid, wherein the anti-diabetic alcoholic beverage comprises between 0.7 and 0.8% topinambour extract prepared by hydrolysis in the presence of 1.18 g/liter succinic acid and 2.68 g/liter malic acid, wherein the alcoholic beverage is prepared by mixing the hydrolyzed topinambour extract with rectified ethanol in water to a concentration of ethanol greater than or equal to 40%.

The anti-diabetic alcoholic beverage further comprises glycerin [CH₂OH—CHOH—CH₂OH], mannite (mannitol) [CH₂OH—(CHOH)₄—CH₂OH], inosit (inositol) [C₆H₁₂O₆], sorbite (sorbitol) and xylite, wherein the total quantity of the additives is between 0.14 to 0.18%.

The anti-diabetic alcoholic beverage may optionally comprise inulin (fructose polymer) [(C₆H₁₀)₅)X], may also optionally comprise compounds lactose and/or lactulose, may also optionally comprise star anise and may optionally comprise natural honey from flowers at a concentration of 5 g/liter.

The anti-diabetic alcoholic beverage is prepared by washing topinambour bulbs, crushing or smashing the topinambour bulbs, wherein one part of topinambour extract is added to three to six parts of 28% ethanol at a pH of 3.5 to 4.8, between four to eight degrees Celsius, in the absence of light, and wherein the pH is adjusted by addition of citric acid in a concentration of 3.8 g/liter, to prepare a topinambour extract, which is then allowed to settle and is subsequently filtered.

The hydrolysis is carried out between 53 to 65 degrees Celsius over a 12 hour period at a pH of between 2.5 to 3.5 in the presence of succinic acid at a concentration of 1.18 g per liter of solution and malic acid at a concentration of 2.68 g to 1 liter of solution.

Glycerin, sorbitol, manitol, xylite and/or inositol may be added in total quantity of 0.14 to 0.18%, and flavorings such as, for exemplary purposes only, star anise, aromatic alcohol-containing compounds and natural honey from flowers may be added.

The resulting vodka has been found to be consumable by diabetics, enhance recovery from radiation treatment and to prevent radiation damage.

More specifically, the present invention is a spirit rectification process is carried out to purify and concentrate ethanol made from, for exemplary purposes only, potatoes, sugar beets or grains. Drinking water of maximum hardness 0.36 mg-ekv, having an ionic content of silver (I) (Ag⁺) of between 0.03 and 0.05 mg/liter) is combined with the rectified ethanol to an ethanol concentration of greater than or equal to 40%.

The resulting ethanol may be tested for quality according to established standards for vodka preparation, such as, governmental standards for vodka distillers. If needed, further purification by filtration through activated charcoal takes place.

Hydrolyzed topinambour extract is added to the filtered ethanol and additional components, such as mannitol, sorbitol, inositol, xylite and glycerin are added, along with star anise and/or other aromatic alcohols.

The vodka is allowed to settle and cure, quality is tested, ethanol content is adjusted to 39.9 to 40.1% by volume, the vodka is bottled and inspected.

The vodka prepared in accordance with the preferred embodiment in the indicated component concentrations provides preventive properties for diabetic use, and for radiation treatment recovery and radiation damage prevention.

Notwithstanding the beneficial effects of the alcohol of the present invention, it is noted though that excessive use of alcohol is harmful to one's health and use of alcohol is prohibited for children and young adults under certain ages, as well as pregnant women and breast-feeding mothers, and to individuals with an unhealthy central nervous system. Further, it is not recommended that the alcohol of the present invention be utilized by individuals who may drive vehicles after consumption.

Accordingly, a feature and advantage of the present invention is that it is ecologically clean.

Another feature and advantage of the present invention is that it does not contain sugar syrups, glucose or vinegar acids.

Still another feature and advantage of the present invention is its ability to utilized by diabetics who otherwise could not drink alcohol.

Yet another feature and advantage of the present invention is its ability to enhance recovery from radiation treatment and to prevent radiation damage.

Yet still another feature and advantage of the present invention is that it provides increased free radicals.

A further feature and advantage of the present invention that it is tasty and aromatic.

These and other features and advantages of the present invention will become more apparent to one skilled in the art from the following description and claims when read in light of the accompanying drawings.

### DETAILED DESCRIPTION OF THE PREFERRED EMBODIMENTS OF THE INVENTION

In describing the preferred embodiments of the present invention, specific terminology is employed for the sake of clarity. The invention, however, is not intended to be limited to the specific terminology so selected, and it is to be understood that each specific element includes all technical equivalents that operate in a similar manner to accomplish similar functions.

A preferred embodiment comprises vodka made from topinambour hydrolyzed extract added to rectified ethanol [CH₃₋CH₂₋OH]. The ethanol is traditionally prepared to a concentration level of greater than or equal to 40% ethanol by combining with drinking water of a controlled hardness of 0.36 mg-ekv containing silver (I) ions (Ag⁺) between 0.03 and 0.05 mg/liter. In distillation of typically all vodka types, tasted or reformed drinking water is one of the basic conditions of obtaining high-quality spirits (vodka). Silver (I) ions (Ag⁺⁾ are mixed in the distilled water by electrochemical means, utilizing pure silver (99.99% Ag) as the electrode. The silver concentration depends on the electrolysis time.

The vodka of the preferred embodiment contains topinambour hydrolyzate as a beneficial and flavoring component. One part of topinambour is added to three to six parts of 28% ethanol to obtain an extract that is subsequently hydrolyzed. 0.7% to 0.8% of the hydrolyzate is added to 40% ethanol according to the method described hereinbelow.

Subsequently, glycerin [CH₂OH—CHOH—CH₂OH], mannite (mannitol) [CH₂OH—(CHOH)₄—CH₂OH], inosit (inositol) [C₆H₁₂O_{6]} and inulin (fructose polymer) [(C₆H₁₀O₅)ₓ] are added to a combined concentration of 0.14 to 0.18%, along with 5 g of natural honey from flowers. Optionally, lactose, lactulose, xylite (xylitol) [CH₂OH—(CHOH)₃—CH₂OH] and star anise may be added as required.

### Topinambour Extraction

The extraction of topinambour bulbs by ethanol comprises the following steps:

1. The topinambour bulbs are washed.

2. The topinambour bulbs are smashed.

3. One part smashed topinambour bulbs are added to three to six parts 28% ethanol [CH₃—CH₂—OH] as the solvent. Extraction from the smashed or crushed topinambour bulbs is carried out between four to eight degrees Celsius in the absence of light. Citric acid [COOH—CH₂₋COHCOOH—CH₂₋COOH, also known as lemon acid] of amount 3.8 g/liter is added to the ethanol solution. The citric acid, for exemplary purposes only, in the form of lemon juice is added to bring the pH of the solution to between 3.5 to 4.8.

4. The extract is subsequently allowed to settle and is then filtered.

### Topinambour Acid Hydrolysis

5. Acid hydrolysis of the topinambour bulb extract retentate is next carried out utilizing 40% ethanol to which succinic acid (HOOC—CH₂—CH₂—COOH) (amber acid) at a concentration of 1.18 g amber acid per liter of solution has been added and to which malic acid (HOOC—CH₂—CHOH—COOH) (apple acid, for exemplary purposes only, in the form of apple juice) at a concentration of 2.68 g to 1 liter of solution has been added. The acid hydrolysis is carried out at between 53 to 65 degrees Celsius over a 12 hour period at a pH of between 2.5 to 3.5.

6. After the 12 hour period, the solution is cooled to five degrees Celsius and held at this temperature for between 24 to 36 hours to allow settling of the suspended particles, after which the solution is filtered. (The hydrolyzed topinambour bulb extract retentate in 40% ethanol acid retains its qualities for up to 18 months after hydrolysis.)

Vodka Preparation from Acid-hydrolyzed Topinambour Extract

A. To make vodka, add 0.7-0.8% hydrolyzed topinambour bulb solution from step 6 (7 to 8 ml per 1 liter) 40.1% rectified ethanol prepared traditionally.

B. 5 g of natural honey from flowers is added per liter of the vodka of step A.

C. Glycerin, sorbitol, mannitol, xylite, inositol in total quantity of 0.14 to 0.18% are added.

D. Flavorings, such as, for exemplary purposes only, star anise or other aromatic compound containing alcohols, may also be selectively utilized according to taste, by making a colloidal muddy suspension in alcohol, which is held for 15 days.

### EXAMPLE OF PREPARATION OF A VODKA BEVERAGE

a. A spirit rectification process is carried out to purify and concentrate ethanol made from, for exemplary purposes only, potatoes, sugar beets or grains.

b. Drinking water of maximum hardness 0.36 mg-ekv, having an ionic content of silver (I) (Ag⁺) of between 0.03 and 0.05 mg/liter) is combined with rectified ethanol to a concentration of greater than or equal to 40% ethanol.

c. Optionally, test for qualitative class in accordance with established standards for vodka preparation as are known in the art.

d. The solution is selectively filtered for further purification through activated charcoal if a qualitative class below “luxe” (good) or “extra” (best) occurs). Make up rectified ethanol may selectively be added as necessary.

e. Hydrolyzed strawberry topinambour is added to the filtered ethanol. It will be recognized by those skilled in the art that high quality food spirit could be utilized.

f. Remaining components are added to the vodka.

g. The vodka is allowed to settle and cure.

h. The filtration operation is inspected (silver filtration process).

i. Ethanol content of the vodka is adjusted to between 39.9 and 40.1% vol.

j. Vodka is poured into bottles.

k. The bottles are sealed.

l. The filled bottles are inspected.

m. An adhesive label is added to the filled bottles.

n. The bottles are boxed into cases.

(Blending of ready-made vodka from above-listed components in the indicated concentrations shall not exceed 20 grams in conversion to absolute model as is known in the art, in order to provide treatment-preventive properties of the vodka dependent on the quality of applied components, moderate usage of the vodka during a meal, and general day-to-day usage of the vodka.)

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An anti-diabetic alcoholic beverage comprising:
topinambour extract, prepared in the presence of citric acid; and
rectified ethanol mixed with water to a concentration of ethanol greater than or equal to 40%, wherein said topinambour extract is prepared by hydrolysis in the presence of succinic acid and malic acid.

2. The anti-diabetic alcoholic beverage of claim 1, wherein said citric acid comprises a concentration of 3.8 g/liter.

3. The anti-diabetic alcoholic beverage of claim 2, wherein said malic acid comprises a concentration of 2.68 g/liter.

4. The anti-diabetic alcoholic beverage of claim 3, wherein said succinic acid comprises a concentration of 1.18 g/liter.

5. The anti-diabetic alcoholic beverage of claim 4, further comprising additives selected from the group consisting of glycerin [CH₂OH—CHOH—CH₂OH], mannite [CH₂OH—(CHOH)₄—CH₂OH], inosit (inositol) [C₆H₁₂O₆], sorbite (sorbitol), xylite, and combinations thereof.

6. The anti-diabetic alcoholic beverage of claim 5, wherein said additives comprise a total of 0.14 to 0.18% by volume.

7. The anti-diabetic alcoholic beverage of claim 6, optionally comprising inulin (fructose polymer) [(C₆H₁₀O₅)X].

8. The anti-diabetic alcoholic beverage of claim 6, optionally comprising compounds selected from the group consisting of lactose, lactulose, and combinations thereof.

9. The anti-diabetic alcoholic beverage of claim 6, optionally comprising star anise.

10. The anti-diabetic alcoholic beverage of claim 6, optionally comprising natural honey from flowers.

11. The anti-diabetic alcoholic beverage of claim 10, wherein said natural honey comprises a concentration of 5 g/liter.

12. A method of making an anti-diabetic alcoholic beverage, said method comprising the steps of:
washing topinambour bulbs;
crushing said topinambour bulbs;
extracting topinambour extract, wherein one part of topinambour extract is added to three to six parts of 28% rectified ethanol at a pH of 3.5 to 4.8, between four to eight degrees Celsius, in the absence of light, wherein said pH is adjusted by addition of citric acid in a concentration of 3.8 g/liter; and
hydrolyzing said topinambour extract; and
mixing 0.7-0.8% of said hydrolyzed topinambour bulb extract with 40.1% rectified ethanol, thereby making topinambour vodka.

13. The method of claim 12, wherein said step of extracting topinambour extract further comprises the steps of:
allowing said topinambour extract to settle, and
filtering said topinambour extract.

14. The method of claim 13, wherein said step of hydrolyzing said topinambour extract further comprises the steps of:
adding succinic acid at a concentration of 1.18 g amber acid per liter of solution;
adding malic acid at a concentration of 2.68 g to 1 liter of solution; and
carrying out said hydrolysis between 53 to 65 degrees Celsius over a 12 hour period at a pH of between 2.5 to 3.5.

15. The method of claim 13, further comprising the steps of:
settling suspended particles; and
filtering.

16. The method of claim 13, further comprising the step of:
adding glycerin, sorbitol, manitol, xylite and inositol in total quantity of 0.14 to 0.18%.

17. The method of claim 13, further comprising the step of:
adding flavorings selected from the group consisting of star anise and aromatic alcohol-containing compounds.

18. The method of claim 13, further comprising the step of:
adding 5 g of natural honey from flowers per liter.

19. An alcoholic beverage comprising:
hydrolyzed topinambour extract of between 0.7 and 0.8% in 40% rectified ethanol wherein said topinambour extract is obtained in the presence of 3.8 g/liter of citric acid.

20. The alcoholic beverage of claim 19, wherein said hydrolyzed topinambour extract is prepared by hydrolysis from a solution comprising:
1.18 g/liter succinic acid; and
2.68 g/liter malic acid.
